(19) United States
(12) Patent Application Publication
(10) Pub. No.: US 2023/0257619 A1
(43) Pub. Date: Aug. 17, 2023

(54) Curing of reaction resins using unsaturated peroxides as initiators and organic phosphites as accelerators

(71) Applicant: Röhm GmbH, Darmstadt (DE)

(72) Inventors: Janos Lotz, Gelnhausen (DE); Alexander Klein, Gau-Algesheim (DE)

(73) Assignee: Röhm GmbH, Darmstadt (DE)

(21) Appl. No.: 18/002,796

(22) PCT Filed: Jun. 1, 2021
(86) PCT No.: PCT/EP2021/064600

§ 371 Date: Dec. 21, 2022

(30) Foreign Application Priority Data
Jun. 23, 2020 (EP) 20181562.8

(51) Int. Cl. C09D 151/00; C08K 5/101; C08K 5/14

(52) U.S. Cl. CPC C09D 151/003; C08K 5/101; C08K 5/14

(57) ABSTRACT

A novel reaction resin formulation having a significantly improved properties profile contains crosslinkers, monomers, urethane methacrylates, prepolymers, optional further auxiliaries, and a curing system containing permaleinates and a tertiary organic phosphite. The reaction resin formulation is useful for marking driving surfaces or coating surfaces. The reaction resins, above all based on a novel curing system, show an improved combination of higher long-term storage stability, improved toxicological profile, reduced curing time, a low yellowing tendency and a better colour fastness.

### FIELD OF THE INVENTION

The present invention relates to novel reaction resin formulations, e.g. for the marking of driving surfaces or for the coating of surfaces, which compared to the prior art provide a significantly improved profile of properties. These reaction resins, above all based on a novel curing system, show an improved combination of higher long-term storage stability, improved toxicological profile, reduced curing time and low yellowing tendency and improved colour fastness.

A series of requirements are placed on modern roadway markings. On the one hand, such systems are expected to be easily applicable to the street surface and at the same time have high storage stability, as well as a long useful life of the finished marking. Also important are rapid processability and particularly processability in the broadest possible time window. Furthermore, it is required for the reaction resins used to be as unproblematic as possible toxicologically and for no acutely toxic raw materials to be handled during their production. In particular, reaction resins showing rapid curing and the lowest content possible of accelerating amines are required. On the one hand, the latter constitute a danger to the health of those processing them. On the other hand, undesirable side effects occur, such as e.g. yellowing of the coatings on UV exposure.

### PRIOR ART

At present, systems such as solvent-based paints, water-based paints, thermoplastic paints, paints based on reaction resins and prefabricated tapes are used as roadway marking materials. The latter have the drawback of being difficult to produce and apply. With respect to the desired durability of the marking as well, there are only limited degrees of freedom with respect to the configuration of the marking, e.g. with glass beads.

Thermoplastic coatings, which are applied to the roadway marking materials in a molten state, can also be optimised per se for a rapid curing rate. There use has the great drawback of requiring an additional method step in that the product must first be made molten, e.g. at 200° C., before it can be applied. Not only is this potentially dangerous because of the high temperature, but thermoplastic systems per se show increased abrasion and reduced thermal resilience.

Thermoplastic systems often have shorter useful lives than systems that are based e.g. on reaction resins and react during crosslinking.

An established system for the marking of streets or floor coatings are the so-called reaction resins. As a rule, these are 2K systems containing monomers, polymers and further components such as e.g. fillers, auxiliaries or glass beads. The one component of the 2K systems therefore contains and initiator component, and the second component contains an accelerator. Prior to application, these two components are mixed with each other and applied to the street or the floor within a pot life. Here, the proper combination of an initiator and a matching accelerator is of great importance. Unsuitable combinations result either in short pot lives with excessive curing prior to application or in long curing times, with very late and usually incomplete curing or the coating.

Moreover, reaction resins are often transported over long distances after their production. In international ocean transport in particular, this results in long transport times. As a rule, resins are not used immediately after their production and must therefore be sufficiently storage stable over long periods. Sufficient storage stability of reaction resins, even at higher temperatures, is advantageous for keeping the requirements low during storage and transport, such as e.g. temperature-controlled transport or storage in refrigerated storage facilities. From the standpoint of security as well, high storage stability is desirable for avoiding uncontrolled polymerisation during production and storage.

As initiators, for cold-curing systems at the ambient temperatures prevailing in outdoor applications such as on streets or rooves, peroxides, such as e.g. dibenzoyl peroxide, are used as a rule. However, from the standpoint of ecological toxicity, dibenzoyl peroxide is problematic as it is harmful to aquatic organisms with a long-term action.

As accelerators in cold-curing systems, tertiary aromatic amines such as e.g. N,N-dimethyl-p-toluidine, N,N-bis-(2-hydroxyethyl)-p-toluidine or N,N-bis-(2-hydroxypropyl)-p-toluidine are ordinarily used. Such aromatic amines are also toxicologically problematic.

Reaction resins for the coating of street surfaces containing such components are described for example in WO 2011/091908. DE 102012210121 A1 describes asymmetric aromatic amines as accelerators that are toxicologically unproblematic. In the systems described, the yellowing that is typical for aromatic amines cannot be completely avoided. This effect is undesirable for coatings and particularly street markings.

An approach for improved curing and at the same time allowing lower yellowing values is the development of new curing systems not using aromatic amines.

U.S. Pat. No. 3,639,370 describes trialkyl phosphites with a chain length of 1 to 6 carbon atoms and triarylphosphites for the activation of permaleinates. Short-chain trialkyl phosphites, and particularly the triethyl phosphate preferred for activation of the compound described, however, because of their low odour threshold, are extremely foul-smelling even in low concentrations, so that their use in reaction resins in open-atmosphere processing is problematic. Furthermore, the short-chain trialkyl phosphites described in U.S. Pat. No. 3,639,370 for the activation of permaleinates also show the considerable drawback of leading in very short time to gelling of the reaction resin, with the result that only an extremely short processing time is available. In practice, an excessively short processing time leads to poor applicability, as curing or polymerisation of the reaction resin occurs too soon. In Example 47 of U.S. Pat. No. 3,639,370, a gelling time of 1 min and a duration of 7 min are mentioned in order to reach the maximum temperature in curing in the use of triethyl phosphite. It follows from this that the curing time more than 7 minutes. In view of the extremely short gelling time, manual processing of these systems is not possible in practice. Even in machine laying. e.g. in the spraying method, extremely short pot lives pose a challenge, because in the event or an interruption, only a very short period of time remains for the cleaning of contaminated machine parts. Moreover, U.S. Pat. No. 3,639,370 describes further compounds for the activation of permaleinates, which however are toxicologically problematic, and in some cases carcinogenic, and are predominantly characterized by an unpleasant odour.

WO 2012/146438 A1 discloses in turn an accelerator system that contains a combination of permaleinates with zinc, sulphur and phosphorus compounds for the curing of (meth)acrylate resins in thin layers. However, the major drawback of this curing system is that the corresponding reaction resins have only short pot lives or processing times, and at the same time, a relatively long curing time is required until a tack-free surface is achieved. Example 15 of WD 2012/148438 mentions a gelling time of 3 min and a curing time of 35 min. In practice, this again allows only machine processing, e.g. by the spray method, for the marking of streets. Compared to conventional cold spray plastic systems with BPO/amine curing systems having typical curing times of less than 10 minutes, the system disclosed in WO 2012/146438 is much slower with respect to complete curing. This means that corresponding coatings cannot be driven over until later, which causes traffic to be blocked longer during road marking work.

### OBJECTS

The object of the present invention, in view of the discussed prior art, is to provide a novel reaction resin that poses fewer risks to humans and the environment compared to the prior art. This means in particular that the activators or accelerators used should be less problematic from the standpoint of human toxicology and the initiators used should be less toxic to aquatic organisms.

Additionally, an object of the present invention is to provide a reaction resin which, compared to the prior art, has a sufficient pot life and thus leads to a coating that can be processed both by machine, with prompt drive-over capability, as well as manually. In particular, the curing time should be a maximum of five times the pot life. This means that the coating will quickly be capable of mechanical loading, so that for example a freshly-applied street is promptly capable of being driven over by traffic.

Additionally, an object is that the reaction resin should be capable of use, particularly even at cooler application temperatures, i.e. for example in the range between 5° C. and 25° C., and also in contact with oxygen or air, and should show tack-free curing.

Additionally, an object is to provide reaction resins which, after application in a suitable composition, particularly under UV weathering, show virtually no discoloration, such as e.g. yellowing, over a long period of time.

Additionally, the 2K reaction resins to be newly developed, compared to the 2K resins known in the prior art with e.g. a curing system based on dibenzoyl peroxide and amines applied as road markings, should show comparable mechanical properties as well as comparable durability. For technically simple production and processing of the reaction resins, the accelerator component in particular should be liquid at room temperature so that simple mixing into a reaction resin is possible. In this manner, at low temperatures, reaction resins can as needed be additionally activated shortly prior to application, e.g. at a building site, by the addition of further accelerators.

Application of the reaction resins to be newly developed is limited in this case not only to roadway markings, but they can also be used in other fields of application, such as e.g. reactive coatings and reactive seals, such as roof and bridge seals, floor coatings, corrosion protection and intumescent coatings, but also in reaction resin compositions e.g. for artificial stone, polymer concrete, sanitary products or also dental or orthopaedic resins or bone cement, and reaction resin compositions for adhesives.

Other objects that are not specifically mentioned are derived from the overall context of the following description, claims and examples.

### SOLUTION

The objects are achieved by providing a novel 2K reaction resin system which contains in one component at least one organic phosphite having a longer alkyl group compared to the prior art as (an) accelerator(s) and in the other component an unsaturated peroxide as an initiator.

Here, according to the invention, the two components of the (meth)acrylate-based 2K reaction resin contain together the following ingredients:

0% by weight to 30% by weight of crosslinkers,

20% by weight to 85% by weight of monomers.

0% by weight to 80% by weight of urethane (meth)acrylates,

0% by weight to 40% by weight or prepolymers,

optionally further auxiliaries and

1.15% by weight to 10% by weight of a curing system containing

0.15% by weight to 5% by weight of permaleinates and

1.0% by weight to 10% by weight of a tertiary organic phosphite.

The amounts given for the permaleinate and the tertiary organic phosphites are based on the total amount of the 2K reaction resin.

Here, the permaleinate(s) on the one hand and the tertiary organic phosphite on the other are for mixing together of the two components contained in separate components of the 2K reaction resin. Furthermore, the 2K reaction resin according to the invention is characterised in that the tertiary organic phosphite has the general formula P(OR1)(OR2)(OR3), wherein R1, R2 and R3 are identical or are groups differing from one another and at least one of these groups has more than 8 C atoms.

If crosslinkers are present, they are preferably used in a minimum concentration of 0.5% by weight.

Preferred here is a composition in which the two components together contain the following ingredients:

2% by weight to 20% by weight, particularly preferably 3% by weight to 15% by weight of crosslinkers, preferably multifunctional (meth)acrylates, most particularly preferably di-, tri- or tetra-(meth)acrylates,

25% by weight to 75% by weight, particularly preferably 30 to 40% by weight of (meth)acrylates and/or monomers copolymerisable with (meth)acrylates, wherein the content of acrylates is a maximum of 5% by weight of the 2K reaction resin,

0% by weight to 45% by weight, particularly preferably up to 30% by weight of urethane (meth)acrylates,

10% by weight to 35% by weight, particularly preferably 15% by weight to 25% by weight of prepolymers, preferably poly(meth)acrylates and/or polyesters, particularly preferably poly(meth)acrylate,

optionally further auxiliaries and

2% by weight to 7.5% by weight, particularly preferably 2% by weight to 7% by weight of a curing system containing, based on the 2K reaction resin, 0.5% by weight to 4.0% by weight, particularly preferably 0.75% by weight to 3.5% by weight of permaleinates and

1.5% by weight to 6.0% by weight, particularly preferably 2.0% by weight to 5.0% by weight of a tertiary organic phosphite as ingredients.

The further auxiliaries can e.g. be stabilisers, inhibitors, chain-transfer agents or waxes. Preferably, the reaction resin according to the invention is halogen-free.

The permaleinate is preferably tert-butyl monoperoxomaleic acid ester.

In a particular embodiment of the present invention, the 2K reaction resins are resins that have a particularly high content of urethane (meth)acrylates. Such 2K reaction resins preferably contain, in both components of the reaction resin together,

0% by weight to 20% by weight of multifunctional (meth)acrylates,

25% by weight to 75% by weight of (meth)acrylates and/or monomers copolymerisable with (meth)acrylates, wherein the content of acrylates is a maximum of 5% by weight of the 2K reaction resin,

10% by weight to 60% by weight of urethane (meth)acrylates,

10% by weight to 35% by weight of prepolymers,

optionally further auxiliaries and

2.0% by weight to 7.5% by weight of a curing system containing, based on the 2K reaction resin,

0.5% by weight to 4.0% by weight of permaleinates and

1.5% by weight to 6.0% by weight of a tertiary organic phosphite as ingredients.

Surprisingly, it was found that by means of an organic phosphite, the activation reaction is accelerated compared in particular to systems according to the prior art to such an extent that curing occurs even at 5° C. and below. Furthermore, the curing is accelerated to such an extent that shorter curing times are achieved.

As the organic tertiary phosphite, alkyl, aryl, alkoxyaryl, alkoxyalkyl, and heterocyclic tertiary phosphites and tertiary thiophosphites with the formula P(XR1)(XR2)(XR3) are used. Here, R1, R2 and R3 denote alkyl, cycloalkyl, aryl, alkoxyalkyl, arylalkyl or tetrahydrofurfuryl groups that are either identical to or different from one another. X can be oxygen or sulphur.

Typical examples of such tertiary phosphites or thiophosphites used according to the invention are tri-2-ethylhexyl phosphite, tri-2-ethylhexyl trithiophosphite, triisooctyl phosphite, triisooctyl trithiophosphite, tridecyl phosphite, tridecyl trithiophosphite, trilauryl phosphite, trilauryl trithiophosphite, trioctadecyl phosphite, trioctadecyl trithiophosphite, phenyl didecyl phosphite, phenyl didecyl trithiophosphite, phenyl dilauryl phosphite, phenyl distearyl phosphite, phenyl distearyl trithiophosphite, diphenyl decyl phosphite, diphenyl lauryl phosphite, diphenyl stearyl phosphite, diphenyl stearyl trithiophosphite, tri-para-cresyl phosphite, tri-metacresyl phosphite, tri-orthocresyl phosphite, tri-paracresyl dithiophosphite, tri-paraoctyl phenyl trithiophosphite, tri-orthooctyl phenyl phosphite, tris(dipropylene glycol) phosphite, triethoxy ethyl phosphite, tributoxyethyl phosphite, tritetrahydrofurfuryl phosphite, tritetrahydrofurfuryl trithiophosphite, tri phenylethyl phosphite, S-phenyl dilauryl monothiophosphite, S-phenyl didecyl monothiophosphite, SS-diphenyl lauryl dithiophosphite, SS-diphenyl decyl dithiophosphite, tri-orthonaphthyl phosphite, SS-diphenyl decyl dithiophosphite, phenyl dilauryl trithiophosphite, tris-dodecyl phenyl phosphite, triochlorophenyl phosphite, diphenyl lauryl trithiophosphite, S-lauryl diphenyl monothiophosphite, tri-p-methoxyphenyl phosphite, SO-diphenyl-S-lauryl dithiophosphite, trio-methoxyphenyl dithiophosphite, SS-dilauryl phenyl dithiophosphite, and SO-dilauryl-S-phenyl dithiophosphite.

The tertiary organic phosphites are preferably compounds with three identical alkyl groups R1, R2 and R3, wherein all three alkyl groups accordingly have more than 6 C atoms. A particularly preferred example of the tertiary organic phosphite is triisodecyl phosphite.

Additionally, the reaction resin according to the invention can further contain accelerators, for example in the form of symmetrical tertiary aromatic amines as they are known from the prior art. In such an embodiment of the invention, this addition causes further acceleration of the reaction resin and reduced curing time compared to the prior art. Examples of said symmetrical tertiary aromatic amines include N,N-dimethyl-p-toluidine. N,N-bis-(2-hydroxyethyl)-p-toluidine or N,N-bis-(2-hydroxypropyl)-p-toludine.

However, embodiments are preferred in which organic phosphites are exclusively used as accelerators and the 2K reaction resin accordingly contains no amines in total. Surprisingly, it was found that reaction resins could be cured using an established system with a speed comparable to that of the prior art and without the presence of an amine. This means that on the whole, the formulation is more uncritical from a toxicological standpoint than the systems of prior art.

Preferably, the 2K reaction resin according to the invention contains less than 5% by weight of acrylates, and particularly preferably no acrylates.

The 2K reaction resin according to the invention can be provided in various embodiments. In a first such embodiment, the second component of the reaction resin consists exclusively of components of the curing system. These are then not contained in the first component of the 2K reaction resin. In such an embodiment, for example, the accelerator is added to the other components containing an initiator before mixing and application. Alternatively, the initiator can be added correspondingly to a reaction resin that contains the accelerator but is otherwise completely formulated.

In a further embodiment, the first and the second component of the reaction resin have the identical composition, with the exception of the components of the curing system. In this case, the two individual components, containing on the one hand the initiator and on the other the accelerator, are mixed with each other before application.

Further embodiments, e.g. divided among more than two components, are also conceivable.

It has been found to be highly favourable if the 2K reaction resin according to the invention additionally contains 0.3% by weight to 3% by weight of one or more paraffins. These paraffins are characterized in that their congealing point according to DIN-ISO 2207 is in the temperature range of 35° C. to 75° C.

Surprisingly, it was also found that embodiments of the 2K reaction resin according to the invention can be used in a particularly advantageous manner when the 2K reaction resin, based on the total of acrylate and methacrylate groups, contains a maximum of 5% by weight of acrylate groups. In this view, therefore, not only the polymerisable acrylate and methacrylate contents of the monomers are taken into consideration, but also further groups, as they are or may be included in particular in the crosslinkers or the urethane (meth)acrylates.

In particular, in addition to the 2K reaction resins described, cold plastics produced with these 2K reaction resins are also part of the present invention. These cold plastics contain the following components:

This cold plastic according to the invention can for example be used in road markings, seals or floor coatings. In particular, it is characterised in that the cold plastic contains

5% by weight to 80% by weight, preferably 10% by weight to 60% by weight of the 2K reaction resin according to the above description,

0.15% by weight to 25% by weight, preferably 1% by weight to 20% by weight and particularly preferably 1.5% by weight to 15% by weight of one or more pigment, preferably inorganic pigments, particularly preferably titanium dioxide,

15% by weight to 90% by weight of inorganic or mineral fillers,

0% by weight to 5% by weight, preferably 0.3% by weight to 3% by weight of further stabilisers and/or additives not contained in the 2K reaction resin and

0% by weight to 90% by weight of organic, preferably polymeric filers as components.

Preferably, the total amount of the fillers accounts for 50% by weight to 80% by weight of the cold plastic.

The components of the cold plastic are mixed for use in the marking of driving surfaces before or during application to the driving surfaces. In other uses, mixing of the components is accordingly carried out shortly prior to pouring, coating or filing. In this case, for example, final formulation of the cold plastic and mixing of the individual components of the 2K reaction resin can for example take place simultaneously.

Surprisingly. It was found that the cold plastics according to the invention used as street markings can be driven on again in a particularly short period of time. The term drive-over capability or synonymously used phrase capacity to be driven on again are understood to refer to a load applied to the road marking, e.g. In the form of a vehicle driving over it. The period until drive-over capability is achieved is the period between application of the road marking to the point in time when the marking compound is no longer spread on the roadways when tires pass over it.

### DETAILED DESCRIPTION OF THE COMPONENTS OF THE COLD PLASTIC OR THE REACTION RESIN

Additionally, the cold plastic or cold spray plastic can contain further auxiliaries such as crosslinking or dispersing agents, a non-slip filler that improves slip resistance and anti-settling agents. Glass beads can also be added to improve reflection or may already be contained in a component of the cold plastic. Alternatively, the glass beads can be put into place after application to the surface. In this process, used for example in modern marking vehicles with a second nozzle, after application of the first two components, the beads are directly sprayed into these components. The advantage of this process is that only the portion of the glass beads embedded in the marking matrix is wetted with the ingredients of the other two components, and one thus obtains optimum reflection properties. Most particularly, however, in application of this process, particularly good embedding of the glass beads and correspondingly good adhesion of the marking matrix or the road marking formulation to the surface of the glass beads are important. Surprisingly, it was found that the reaction resin according to the invention or the cold spray plastic containing this reaction resin fulfil these required properties at least to the level of the prior art. The required properties for a street marking are precisely specified in DIN EN 1436.

In order to further improve the required properties, the glass beads can be applied together with adhesion promoters or be pre-treated with such adhesion promoters. In this manner, the retro-reflection properties and the day or night visibility of the cold plastic according to the invention are at least comparable to the prior art. The same applies to durability, particularly of embedding the glass beads.

In the novel curing system, unsaturated peroxides, particularly tert-butyl permaleinate, are used as initiators. In some cases, it can be advantageous to use a mixture of various initiators. As a rule, the peroxide in the second component is mixed with a diluent such as an oil or a plasticiser. However, the aforementioned concentrations in the reaction resins according to the invention refer only to the pure initiator.

An optional component of the reaction resin according to the invention are crosslinkers, in particular multifunctional methacrylates such as allyl (meth)acrylates. Particularly preferred are di- or tri-(meth)acrylates such as e.g. 1,4-butanediol di(meth)acrylate, poly(urethane) (meth)acrylates, tetraethylene glycol di(meth)acrylate, triethylene glycol di(meth)acrylate or trimethylolpropane tri(meth)acrylate.

The optionally contained urethane (meth)acrylates are understood in the context of this invention to refer to compounds that contain (meth)acrylate functionalities that are bonded to one another via urethane groups. They are obtainable by reacting hydroxyalkyl (meth)acrylates with polyisocyanates and polyoxyalkylenes that have at least two hydroxy functionalities. Instead of hydroxyalkyl (meth)acrylates, esters of (meth)acrylic acid with oxiranes, such as e.g. ethylene or propylene oxide, or corresponding oligo- or polyoxiranes can also be used. For example, an overview of urethane (meth)acrylates with a functionality of greater than two can be found in DE 19902685. A commercially available example produced from polyolene, isocyanates and hydroxyfunctional (meth)acrylates is EBECRYL 210-5129 from Allnex. In a reaction resin, urethane (meth)acrylates, without major temperature-dependency increase flexibility, tear resistance and elongation at break. Surprisingly, it was found that even urethane acrylates containing the novel curing system in higher contents show tack-free curing without problems. This opens up possibilities, while largely dispensing with acrylate monomers that typically have a low glass transition temperature, for producing flexible reaction resins such as those needed for e.g. roadway markings or sealing systems.

In particular, the monomers contained in the reaction resin are compounds selected from the group of (meth)acrylates such as e.g. alkyl (meth)acrylates of linear, branched or cycloaliphatic alcohols with 1 to 40 C atoms, such as e.g. methyl (meth)acrylate, ethyl (meth)acrylate, n-butyl (meth)acrylate, 2-ethylhexyl (meth)acrylate, stearyl (meth)acrylate, lauryl (meth)acrylate; aryl (meth)acrylates such as e.g. benzyl (meth)acrylate; mono(meth)acrylates of ethers, polyethylene glycolenes, polypropylene glycolenes or mixtures thereof with 5 to 80 C atoms, such as e.g. tetrahydrofurfuryl (meth)acrylate, methoxy(m)ethoxy ethyl (meth)acrylate, benzyloxymethyl (meth)acrylate, 1-ethoxybutyl (meth)acrylate, 1-ethoxyethyl (meth)acrylate, ethoxymethyl (meth)acrylate, poly(ethylene glycol) methyl ether (meth)acrylate and poly(propylene glycol) methyl ether (meth)acrylate.

The group or the (meth)acrylates also comprises esters of (meth)acrylic acid with an acetal, ketal or carbonate of glycerol, substituted glycerol or trimethylolpropane or substituted trimethylolpropane.

Preferred examples of such monomers are glycerol formal (meth)acrylate, trimethylolpropane formal (meth)acrylate or isopropylidene glycerol (meth)acrylate (solketal methacrylate).

Surprisingly, it was found that the reaction resin composition according to the invention preferably contains a maximum of up to 5% by weight of acrylate monomers based on the 2K reaction resin. This allows short curing times relative to pot life to be achieved. In a most particularly preferred embodiment, the 2K reaction resin contains no acrylate monomers.

Also suitable as components or monomer mixtures are additional monomers with a further functional group, such as α,β-unsaturated mono- or dicarboxylic acids, for example acrylic acid, methacrylic acid or itaconic acid; esters of acrylic acid or methacrylic acid with divalent alcohols, for example hydroxyethyl (meth)acrylate or hydroxypropyl (meth)acrylate; acrylamide or methacrylamide; or dimethylaminoethyl (meth)acrylate. Further suitable components of monomer mixtures are for example glycidyl (meth)acrylate or silyl functional (meth)acrylate.

In addition to these (meth)acrylates, the monomer mixtures can also contain further unsaturated monomers that are copolymerisable with the aforementioned (meth)acrylates and by means of free-radical polymerisation. These include 1-alkenes or styrenes. In individual cases, the poly(meth)acrylate is selected as appropriate according to content and composition with respect to the desired technical function.

In so-called MO-PO systems, in addition to the listed monomers, polymers, which are referred to for better differentiation in this patent document as prepolymers, are also present, preferably polyesters or poly(meth)acrylates. These are added to the resins in order to improve polymerisation properties, mechanical properties, adhesion to the substrate and optical requirements. As only small amounts and acrylate monomers with a low glass transition temperature are used for flexibilisation of the reaction resins, in addition to methacrylate monomers with a corresponding glass transition temperature, prepolymers with a low glass transition temperature can also be used for this purpose, wherein the prepolymers themselves can in turn be composed of acrylate monomers.

Both the polyesters and the poly(meth)acrylates can have additional functional groups for adhesion promotion or copolymerisation in the crosslinking reaction, such as e.g. In the form of double bonds. Preferably, however, with respect to better colour-fastness of the road marking, the prepolymers do not have any double bonds. Said poly(meth)acrylates are generally composed of the same monomers as those already listed with respect to the monomers in the resin system. They can be obtained by solution, emulsion, suspension, substance or precipitation polymerisation and are added to the system as a pure substance. Said polyesters are obtained in substance via polycondensation or ring-opening polymerisation and are composed of the building blocks known for these applications.

Chain-transfer agents, plasticisers, paraffins, stabilisers, inhibitors, waxes and/or oils may be additionally used as auxiliaries and additives. Paraffins are added in order to prevent inhibition of polymerisation by oxygen in the air. Multiple paraffins with various melting points in various concentrations can be used for this purpose. It has been found to be highly advantageous if the 2K reaction resin according to the invention additionally contains 0.3% by weight to 3% by weight of one or more paraffins. These paraffins are characterised in that their congealing point according to DIN-ISO 2207 is in the temperature range of 35° C. to 75° C.

All compounds known from radical polymerisation can be used as chain-transfer agents. Preferably, mercaptans such as n-dodecyl mercaptan are used. Esters, polyols, oils, low-molecular-weight polyethers or phthalates are preferably used as plasticizers.

UV stabilisers can also be used. Preferably, the UV stabilisers are selected from the group of benzophenone derivatives, benzotriazole derivatives, thioxanthonate derivatives, piperidinecarboxylic acid ester derivatives or cinnamic acid ester derivatives. Among the group of stabilisers or inhibitors, substituted phenols and hydroquinone derivatives are preferably used.

The following components can optionally also be contained in the 2K reaction resin or cold plastic or in other final formulations based on the 2K reaction resins according to the invention:

wetting agents, dispersants and pyridonecarboxylic flow control agents are preferably selected from the group of the alcohols, hydrocarbons, glycol derivatives, derivatives of glycolic acid esters, acetic acid esters and polysiloxanes, polyethers, polysiloxanes, polycarboxylic acids and saturated and unsaturated polycarboxylic acid aminoamides.

Preferably used as rheology additives are polyhydroxycarboxylic acid amides, urea derivatives, salts of unsaturated carboxylic acid esters, alkylammonium salts of acidic phosphoric acid derivatives, ketoximes, amine salts of p-toluenesulfonic acid, amine salts of sulfonic acid derivatives and aqueous or organic solutions or mixtures of these compounds. It has been found that rheology additives based on pyrogenic or precipitated, optionally also silanised, silicic acids with a BET surface of 10 to 700 nm²/g are particularly suitable.

Defoaming agents selected from the group of the alcohols, hydrocarbons, paraffin-based mineral oils, glycol derivatives, derivatives of glycolic acid esters, acetic acid esters and polysiloxanes are preferably used.

Analogous components can be used for the auxiliaries and additives additionally used in the cold plastic.

As mentioned above, one can add to the cold plastics, usable e.g. for road marking, dyes, glass beads, fine and coarse filers, wetting agents, dispersants and flow control agents, UV stabilisers, defoaming agents and rheology additives. Auxiliaries and additives, preferably dyes, are added for areas of application of roadway markings such as e.g. lines, bars or symbols, or zone markings for the identification e.g. of bicycle paths or bus lanes or parking places. Particularly preferred are white, red, blue, green and yellow inorganic pigments, and particularly preferred are white pigments such as titanium dioxide.

Glass beads are preferably used as reflecting agents in formulations for roadway markings and zone markings. The commercial beads ordinarily used have a diameter of 10 μm to 2000 μm, preferably 50 μm to 800 μm. The glass beads can be provided with an adhesion promoter for better processing and adhesion. Preferably, the glass beads can be silanised.

One or multiple mineral fine fillers and coarse fillers may also be added to the cold plastics. These materials also serve as anti-sip agents and are therefore used in particular for improving non-slip properties and additional colouring of the road marking. Fine fillers from the group of the calcium carbonates, barium sulphates, quartzes, quartz powders, precipitated and pyrogenic silicic acids, pigments and cristobalites and corundums are used. Quartzes, cristobalites, corundums and aluminium silicates are used as coarse fillers.

The 2K reaction resins according to the invention allow a freedom of formulation that is so great that said 2K reaction resin or the cold plastics/cold spray plastics according to the invention containing the reaction resin are just as capable of formulation and addition of additives as an established system of the prior art. Therefore, their abrasion resistance, durability, brightness, pigmentation and non-slip properties are at least as good as those of systems of the prior art.

This quality of being at least comparable to the prior art also applies correspondingly to the storage stability of the reaction resin. The system can also be optimised with respect to the substrate to be coated by selecting suitable monomers, prepolymers and/or adhesion promoters. Accordingly, the systems according to the invention can be variably optimised for the marking of asphalt, concrete or natural stone surfaces.

Use of the Reaction Resins or Cold Plastics/Cold Spray Plastics

In addition to the described 2K reaction resins according to the invention and the cold plastics containing them, a method for application of a 2K reaction resin is also a part of the present invention. This process is characterised in that the two components of a 2K reaction resin according to the invention, within 2 min to 40 min before or during application, are mixed with each other on a substrate. Here, the formulation “application to a substrate” is to be interpreted in the broad sense. It therefore includes not only e.g. the coating of surfaces, but also activities such as the filling of moulds.

In this case, the substrate can in particular be driving surfaces, paving stones, concrete, screed, asphalt, ceramic or steel, particularly in the form of a steel girder.

The 2K reaction resin according to the invention further allows the production of yellowing-free artificial stone mouldings at ambient temperature, e.g. the production of sanitary products in unheated moulds.

Preferably, the 2K reaction resins according to the invention or cold plastics containing these reaction resins are used for street marking, particularly for the production of durable roadway markings, or for the coating of floors or seats, particularly in the industrial or commercial field. However, this listing may not be used to limit the application of the reaction resins or cold plastics according to the invention in any way.

The systems according to the invention are also flexibly usable with respect to application technology. For example, the reaction resins or cold plastics according to the invention can be applied in the spraying, casting, or extrusion process or manually by means of a trowel, a roller or a spatula.

The individual components of the cold plastic such as e.g. the 2K reaction resin according to the invention can be mixed before, after or during the further processing, such as e.g. application to a driving surface. The method of mixing in before further processing is established, wherein it should be noted that after mixing in of the curing agent component, there is only a limited period of time available for application, e.g. of 2 or 40 min. Mixing prior to processing is possible for example in modern marking machines, which are equipped with a mixing chamber upstream of the application nozzle. Mixing in of the curing agent after application can e.g. be carried out by subsequent application with two or more nozzles or by applying glass beads that are coated with curing agents. Alternatively, a primer containing the curing components can be pre-sprayed before the cold plastic or cold spray plastic is applied.

Additionally, the mechanical properties of the road marking produced with the 2K reaction resins according to the invention are outstanding in a typical range of between 200 μm and 7000 μm, independently of the application thickness. The application thickness of the cold plastic or cold spray plastic according to the invention is preferably between 400 μm and 1000 μm and particularly preferably between 600 μm and 800 μm. Depending on the application, thicker and thinner layers are also possible.

Preferably, the 2K reaction resins according to the invention or the cold plastic produced therefrom are used for the production of durable roadway markings.

By way of example, the 2K reaction resins or cold plastics are used in a process in which glass beads are added before, during or immediately after application of the cold plastic to a driving surface.

Alternatively, the reaction resins and/or cold plastics according to the invention can also be applied in other technical fields. Examples include floor coverings, preferably for industrial applications, for the production of castings, for the sealing or coating of rooves, bridges or joints thereof, particularly as sealing membranes, for bridge coating in general, as sealing membranes on rooves, for the production or plates, e.g. for re-use as worktops, for the production of protective coatings, particularly for metal surfaces, as channel resin, for the production of sanitary products, for the production of adhesives, for filling cracks, e.g. In buildings, or for use in the field of orthopaedics.

### EXAMPLES

The examples listed below are given in order to better illustrate the present invention, but do not limit the invention to the features disclosed herein.

As a curing agent, a mixture of tert-butyl peroxomaleinate and plasticisers, desensitisers and further auxiliaries having a peroxide content of approx. 25% by weight was used. In particular, in the following—unless otherwise indicated—PEROXAN PM-25 S from the firm Pergan was used.

Pot life was determined as the time required by the material after stirring in of the curing agent to increase from room temperature, i.e. a temperature of between 20 and 22° C., to 32° C. after mixing of the components of the 2K resin. For this purpose, a sample amount of the 2K reaction resin of 20 g was mixed together in a plastic vessel.

In the so-called O test, the time was determined that was required to achieve a tack-free surface. For this purpose, timing was started on stirring of the curing agent into the material, and after complete mixing in of the curing agent, the mixture was poured in a layer thickness of 2 mm into a tin plate cover. The time was then measured until the surface was no longer found to be tacky on touching with a gloved finger. All of the tests were conducted by the same operator.

Curing of Methacrylate-Based Reaction Resins

### Comparative Example 1

In this comparative example, curing of a 2K methacrylate-based reaction resin was carried out with a benzoyl peroxide/N,N′-dihydroxyethyl-p-toluidine curing system according to the prior art. 98.5 g of DEGADUR MDP Membrane SG (commercially available, accelerator-free methacrylate-based reaction resin, firm Röhm GmbH) was mixed with 1.50 g of N,N′-dihydroxyethyl-p-toluidine. After this, for curing, 2.0 g of Perkadox CH-50 (dibenzoyl peroxide powder 50% with dicyclohexyl phthalate, firm Nouryon) was added and stirred until the added peroxide had completely dissolved in the reaction resin.

The following results were obtained:

Pot life: 11 min

Tₘₐₓ=119° C.

Tₘₐₓ after 17 min

O test=23 min

After 24 h, the colour of the 2 mm-thick polymer film from the O test was visually evaluated against a white substrate. Clear yellowing was recognizable.

### Example 1

In this example according to the invention, a corresponding 2K reaction resin was cured with a curing system based on TBPM (tert-butyl permaleinate) and a phosphite.

98.0 g of DEGADUR MDP Membrane SG was mixed with 2.00 g of tris(2-ethylhexyl)phosphite. After this, for curing, 4.0 g of PEROXAN PM-25 S (25% by weight TBPM suspension of tert-butyl permaleinate with plasticisers from the firm Pergan) was added and stirred until the added peroxide had completely dissolved in the reaction resin.

The following results were obtained:

Pot life=10 min

Tₘₐₓ=129° C.

Tₘₐₓ after 15 min

O test=20 min

After 24 h, the colour of the 2 mm-thick polymer film from the O test was visually evaluated against a white substrate. No yellowing was visible.

A comparison of the respective results from comparative example 1 and example 1 shows that the reaction resin according to the invention shows comparable pot and curing times, but does not cause yellowing of the polymers.

### Examples 2 to 4

Curing of the 2K reaction resins of these examples according to the invention with TBPM/phosphite curing systems was carried out as follows:

DEGADUR MDP Membrane SG was mixed in each case with triisodecyl phosphite as an accelerator. The reaction resin was then placed in a climate chamber for heat treatment. After adjustment of the temperature, PEROXAN PM-25 S was then added for curing and stirred until the added peroxide had completely dissolved in the reaction resin. The curing of the reaction resin was also carried out in a climate chamber. The external temperature, respective mixing ratios and measurement results are shown in Table 1:

TABLE 1

| | | | | Curing | | |
|---|---|---|---|---|---|---|
| | | Reaction resin | Accelerator | agent/peroxide | | |
| Example | Temperature | (component 1) | (component 1) | (component 2) | Pot life | O test |
| 2 | 23° C. | 96.0 g of | 4.0 g of triisodecyl | 4.0 g of | 7 min | 16 min |
| | | DEGADUR | phosphite | PEROXAN | | |
| | | MDP | | PM-25 S | | |
| | | Membrane SG | | | | |
| 3 | 10° C. | 96.0 g of | 4.0 g of triisodecyl | 6.0 g of | 8 min | 27 min |
| | | DEGADUR | phosphite | PEROXAN | | |
| | | MDP | | PM-25 S | | |
| | | Membrane SG | | | | |
| 4 | 5° C. | 96.0 g of | 4.0 g of triisodecyl | 6.0 g of | 15 min | 38 min |
| | | DEGADUR | phosphite | PEROXAN | | |
| | | MDP | | PM-25 S | | |
| | | Membrane SG | | | | |

It was shown in examples 2 to 4 that in use of the 2K reaction resin according to the invention, by adjusting the amount of the curing agent over a broad temperature range, even down to low temperatures, it was possible to achieve complete, tack-free curing in a short period, with a pot life long enough for processing practice.

Curing of Reaction Resins Containing Methacrylates and Acrylates

In the following, the effect of acrylates in reaction resins on curing behaviour is to be investigated. In examples 5 to 12, DEGADUR MDP Primer SG B (commercially available, amine-free methacrylate-based reaction resin, firm Röhm GmbH, contains 0.5% by weight of triisodecyl phosphite) was mixed in each case with varying amounts of 2-ethylhexylacrlate and additional triisodecyl phosphite as an accelerator. After this, for curing, PEROXAN PM-25 S (tert-butyl permaleinate, 25%, suspension with plasticisers, firm Pergan) was added and stirred until the added peroxide had completely dissolved in the reaction resin. The respective mixing ratios and the measurement results for examples 5 to 8 are shown in Table 2.

TABLE 2

| | | | | Addition of | | | |
|---|---|---|---|---|---|---|---|
| | | Reaction | Addition | further | Curing | | |
| Example | Temperature | resin | of acrylate | accelerators | agent/peroxide | Pot life | O test |
| 5 | 23° C. | 100.0 g of | — | 3.5 g of | 4.0 g of | 10 min | 40 min |
| | | DEGADUR | | triisodecyl | PEROXAN | | |
| | | MDP Primer | | phosphite | PM-25 S | | |
| | | SG B | | | | | |
| 6 | 23° C. | 95.0 g of | 5.0 g of 2- | 3.5 g of | 4.0 g of | 10 min | 60 min |
| | | DEGADUR | ethylhexylacrlate | triisodecyl | PEROXAN | | |
| | | MDP Primer | | phosphite | PM-25 S | | |
| | | SG B | | | | | |
| 7 | 23° C. | 90.0 g of | 10.0 g of 2- | 3.5 g of | 4.0 g of | 13 min | >150 |
| | | DEGADUR | ethylhexylacrlate | triisodecyl | PEROXAN | | min |
| | | MDP Primer | | phosphite | PM-25 S | | Surface |
| | | SG B | | | | | remains |
| | | | | | | | liquid |
| 8 | 23° C. | 80.0 g of | 20.0 g of 2- | 3.5 g of | 4.0 g of | 13 min | >150 |
| | | DEGADUR | ethylhexylacrlate | triisodecyl | PEROXAN | | min |
| | | MDP Primer | | phosphite | PM-25 S | | Surface |
| | | SG B | | | | | remains |
| | | | | | | | liquid |

It was shown in examples 5 to 8 that the curing properties deteriorated with an increasing content by weight of acrylate monomers. A higher acrylate content is therefore disadvantageous in such novel systems.

The results and compositions of the initiator systems for examples 9 to 12 are shown in Table 3. Large amounts of phosphites were used in these examples 9 to 12.

TABLE 3

| | | Reaction | Addition of | Addition of | Curing | | |
|---|---|---|---|---|---|---|---|
| Example | Temperature | resin | acrylate | further accelerators | agent/peroxide | Pot life | O test |
| 9 | 23° C. | 100.0 g of | — | 7.5 g of | 4.0 g of | 5 min | 23 min |
| | | DEGADUR | | triisodecyl | PEROXAN | | |
| | | MDP Primer | | phosphite | PM-25 S | | |
| | | SG B | | | | | |
| 10 | 23° C. | 95.0 g of | 5.0 g of 2- | 7.5 g of | 4.0 g of | 7 min | 24 min |
| | | DEGADUR | ethylhexylacrlate | triisodecyl | PEROXAN | | |
| | | MDP Primer | | phosphite | PM-25 S | | |
| | | SG B | | | | | |
| 11 | 23° C. | 90.0 g of | 10.0 g of 2- | 7.5 g of | 4.0 g of | 7 min | 30 min |
| | | DEGADUR | ethylhexylacrlate | triisodecyl | PEROXAN | | |
| | | MDP Primer | | phosphite | PM-25 S | | |
| | | SG B | | | | | |
| 12 | 23° C. | 80.0 g of | 20.0 g of 2- | 7.5 g of | 4.0 g of | 6 min | 60 min |
| | | DEGADUR | ethylhexylacrlate | triisodecyl | PEROXAN | | Surface |
| | | MDP Primer | | phosphite | PM-25 S | | remains |
| | | SG B | | | | | slightly |
| | | | | | | | tacky |

Surprisingly, it was found in examples 9 to 12 that in use of larger amounts of the organic phosphite, complete and tack-free curing is also possible with high contents by weight of acrylate monomers.

Calculation of Content of Acrylate Groups in the Compositions According to Examples 5 to 12

For illustrative purposes, the contents by weight of acrylate groups in the resin components of examples 5 to 12 are calculated below.

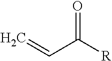

An acrylate group has an equivalent weight of 55.06 g/mol, giving for example a content by weight of 29.9% in 2-ethylhexyacrlate (55.06 g/mol/184.28 g/mol=29.9%).

TABLE 4

| | | | | | | Content |
|---|---|---|---|---|---|---|
| | | | | | | of acrylate |
| | | | | | Percent | groups in |
| | | | | | content of | reaction |
| | | | | | 2-ethylhexylacrlate | resin |
| | | | Addition | | in the | (without |
| | Reaction | Addition | of further | Amount of | reaction resin | curing |
| Example | resin | of acrylate | accelerators | reaction resin | (without curing agent) | agent) |
| 5 | 100.0 g of | — | 3.5 g of triisodecyl | 103.5 g | 10% | 0% |
| | DEGADUR | | phosphite | | | |
| | MDP Primer | | | | | |
| | SG B | | | | | |
| 6 | 95.0 g of | 5.0 g of 2- | 3.5 g of triisodecyl | 103.5 g | 4.83% | 1.44% |
| | DEGADUR | ethylhexylacrlate | phosphite | | | |
| | MDP Primer | | | | | |
| | SG B | | | | | |
| 7 | 90.0 g of | 10.0 g of 2- | 3.5 g of triisodecyl | 103.5 g | 9.66% | 2.88% |
| | DEGADUR | ethylhexylacrlate | phosphite | | | |
| | MDP Primer | | | | | |
| | SG B | | | | | |
| 8 | 80.0 g of | 20.0 g of 2- | 3.5 g of triisodecyl | 103.5 g | 19.32% | 5.78% |
| | DEGADUR | ethylhexylacrlate | phosphite | | | |
| | MDP Primer | | | | | |
| | SG B | | | | | |
| 9 | 100.0 g of | — | 7.5 g of triisodecyl | 107.5 g | 0% | 0% |
| | DEGADUR | | phosphite | | | |
| | MDP Primer | | | | | |
| | SG B | | | | | |
| 10 | 95.0 g of | 5.0 g of 2- | 7.5 g of triisodecyl | 107.5 g | 4.65% | 1.39% |
| | DEGADUR | ethylhexylacrlate | phosphite | | | |
| | MDP Primer | | | | | |
| | SG B | | | | | |
| 11 | 90.0 g of | 10.0 g of 2- | 7.5 g of triisodecyl | 107.5 g | 9.30% | 2.78% |
| | DEGADUR | ethylhexylacrlate | phosphite | | | |
| | MDP Primer | | | | | |
| | SG B | | | | | |
| 12 | 80.0 g of | 20.0 g of 2- | 7.5 g of triisodecyl | 107.5 g | 18.60% | 5.56% |
| | DEGADUR | ethylhexylacrlate | phosphite | | | |
| | MDP Primer | | | | | |
| | SG B | | | | | |

### Example 13

49.0 g of Ebecryl 230 (commercially available urethane acrylate, firm Allnex) was mixed with 46.2 g of methyl methacrylate, 0.80 g of paraffin (Sasolwax 5105) and 4.0 g of trilsodecyl phosphite as an accelerator at 55° C. until the paraffin has completely dissolved. The resin was then cooled to 23° C.

After this, for curing, 4.0 g of PEROXAN PM-25 S (tert-butyl permaleinate, 25%, suspension with plasticisers, firm Pergan) was added and stirred until the added peroxide had completely dissolved in the reaction resin. The composition and results are shown in Table 5.

TABLE 5

| | | Reaction | Content of urethane | Curing | | |
|---|---|---|---|---|---|---|
| Example | Temperature | resin | acrylate in reaction resin | agent/peroxide | Pot life | O test |
| 13 | 23° C. | 100.0 g of | 49.0% | 4.0 g of | 12 min | 35 min |
| | | resin from | | PEROXAN PM- | | |
| | | example | | 25 S | | |
| | | 13 | | | | |

Example 13 shows that it is not the content by weight of acrylate compounds that is relevant for tack-free curing, but the content by volume of functional acrylate groups. Therefore, although there is a high content of acrylate compounds in the form of urethane acrylate, because of the low content by weight of functional acrylate groups, this does not cause any substantial impairment of curing.

1: A (meth)acrylate-based 2K reaction resin, comprising:
two components, wherein the two components of the 2K reaction resin together contain
0% by weight to 30% by weight of at least one crosslinker,
20% by weight to 85% by weight of at least one monomer,
0% by weight to 60% by weight of at least one urethane (meth)acrylate,
0% by weight to 40% by weight of at least one prepolymer,
optionally, at least one further auxiliary, and
1.15% by weight to 10% by weight of a curing system based on the 2K reaction resin containing
0.15% by weight to 5% by weight of at least one permaleinate, and
1.0% by weight to 10% by weight of a tertiary organic phosphite,
as ingredients,
wherein the at least one permaleinate on the one hand and the tertiary organic phosphite on the other are contained in separate components of the 2K reaction resin before the two components are mixed together, and
wherein the tertiary organic phosphite has the general formula P(OR1)(OR2)(OR3), wherein R1, R2 and R3 are identical or are groups differing from one another and at least one of these groups has more than 6 C atoms.

2: The 2K reaction resin according to claim 1, wherein the two components of the 2K reaction resin together contain
2% by weight to 20% by weight of at least one multifunctional (meth)acrylate,
25% by weight to 75% by weight of at least one (meth)acrylate and/or monomer copolymerisable with (meth)acrylates, wherein a content of acrylates is a maximum of 5% by weight of the 2K reaction resin,
0% by weight to 45% by weight of the at least one urethane (meth)acrylate,
10% by weight to 35% by weight of the at least one prepolymer,
optionally, the at least one further auxiliary, and
2% by weight to 7.5% by weight of the curing system containing, based on the 2K reaction resin,
0.5% by weight to 4.0% by weight of the at least one permaleinate, and
1.5% by weight to 6.0% by weight of the tertiary organic phosphite as ingredients.

3: The 2K reaction resin according to claim 1, wherein the two components of the 2K reaction resin together contain
0% by weight to 20% by weight of at least one multifunctional (meth)acrylate,
25% by weight to 75% by weight of at least one (meth)acrylate and/or monomer copolymerisable with (meth)acrylates, wherein a content of acrylates is a maximum of 5% by weight of the 2K reaction resin,
10% by weight to 60% by weight of the at least one urethane (meth)acrylate,
10% by weight to 35% by weight of the at least one prepolymer,
optionally, the at least one further auxiliary, and
2% by weight to 7.5% by weight of the curing system containing, based on the 2K reaction resin,
0.5% by weight to 4.0% by weight of the at least one permaleinate, and
1.5% by weight to 6.0% by weight of the tertiary organic phosphite,
as ingredients.

4: The 2K reaction resin according to claim 1, wherein the two components of the 2K reaction resin together contain
3% by weight to 15% by weight of at least one multifunctional methacrylate,
30% by weight to 40% by weight of at least one (meth)acrylate and/or monomer copolymerisable with (meth)acrylates, wherein based on a total amount of the 2K reaction resin, a maximum of 5% by weight of the monomers are acrylates,
0% by weight to 30% by weight of the at least one urethane (meth)acrylate,
15% by weight to 25% by weight of the at least one prepolymer,
optionally, the at least one further auxiliary, and
2% by weight to 7% by weight of the curing system containing
0.75% by weight to 3.5% by weight of the at least one permaleinate, and
2.0% by weight to 5.0% by weight of the tertiary organic phosphite,
as ingredients.

5: The 2K reaction resin according to claim 1, wherein the at least one permaleinate is tert-butyl monoperoxomaleic acid ester.

6: The 2K reaction resin according to claim 1, wherein the tertiary organic phosphite is triisodecyl phosphite.

7: The 2K reaction resin according to claim 1, wherein the 2K reaction resin contains no amine.

8. The 2K reaction resin according to claim 1, wherein the 2K reaction resin contains no acrylates.

9: The 2K reaction resin according to claim 1, wherein a second component of the 2K reaction resin consists exclusively of components of the curing system that are not contained in a first component.

10: The 2K reaction resin according to claim 1, wherein a first component and a second component of the 2K reaction resin have identical compositions, with the exception of components of the curing system.

11: The 2K reaction resin according to claim 1, wherein the 2K reaction resin contains 0.3% by weight to 3% by weight of one or more paraffins, a congealing point of which according to DIN-ISO 2207 is in the temperature range of 35° C. to 75° C.

12: The 2K reaction resin according to claim 1, wherein the 2K reaction resin, based on a total of acrylate and methacrylate groups, contains a maximum of 5% by weight of acrylate groups.

13. A method for application of a 2K reaction resin, the method comprising:
mixing the two components of the 2K reaction resin according to claim 1 on a substrate, within 2 min to 40 min before or during application.

14: The method according to claim 13, wherein the substrate is a roadway, paving stones, concrete, screed, asphalt, ceramic, or steel.

15: Cold plastic for a road marking, seal, or floor coating, comprising:
5% by weight to 80% by weight of the 2K reaction resin according to claim 1,
0.15% by weight to 25% by weight of one or more pigment,
15% by weight to 90% by weight of one or more inorganic fillers,
0% by weight to 5% by weight of one or more further stabilisers and/or additives not contained in the 2K reaction resin, and
0% by weight to 90% by weight of one or more organic fillers,
as components.

16: The cold plastic according to claim 15, wherein the cold plastic contains:
10% by weight to 60% by weight of the 2K reaction resin,
1.5% by weight to 15% by weight of one or more inorganic pigments,
0.3% by weight to 3% by weight of the one or more further stabilisers and/or additives not contained in the 2K reaction resin, and
50% by weight to 80% by weight of the one or more inorganic fillers and the one or more organic fillers in total, wherein the one or more organic fillers are polymers,
as components.

17: The method according to claim 14, wherein the substrate is a steel girder.

18: The cold plastic according to claim 16, wherein the one or more inorganic pigments is titanium dioxide.
